(19) United States
(12) Patent Application Publication
(10) Pub. No.: US 2006/0286210 A1
(43) Pub. Date: Dec. 21, 2006

(54) Low-phytate infant formulas

(76) Inventors: Nagendra Rangavajla, Newburgh, IN (US); Robert A. Burns, Evansville, IN (US)

Correspondence Address: NELSON MULLINS RILEY & SCARBOROUGH, LLP, MERIDIAN, SUITE 1700, 1320 MAIN STREET, COLUMBIA, SC, 29201, US

(21) Appl. No.: 11/446,769

(22) Filed: Jun. 5, 2006

Related U.S. Application Data
(60) Provisional application No. 60/687,779, filed on Jun. 6, 2005.

(51) Int. Cl. A23L 1/30

(52) U.S. Cl. 426/72

(57) ABSTRACT

The invention is related to an infant formula which has, per 100 kcal, a carbohydrate source, a lipid source, a soy protein source, and a calcium source. The soy protein source can have a phytate level between about 12 mg and about 18 mg. The calcium can be present in an amount between about 70 and about 90 mg.

This application claims the priority benefit of U.S. Provisional Application 60/687,779 filed Jun. 6, 2005.

### BACKGROUND OF THE INVENTION

(1) Field of the Invention

The present invention relates to infant formulas having a reduced phytate content.

(2) Description of the Related Art

By two months of age, the majority of infants in North America are formula-fed. Soy Protein-Based Formulas: Recommendations for Use in Infant Feeding, Pediatr. 101:148-153 (1998). Because these infant formulas provide the largest, if not sole, source of nutrition for most infants in North America, there is great interest in improving the nutritional quality of these infant formulas. Significant research has been devoted to finding the specific combination of lipids, carbohydrates, protein, vitamins, and minerals that support optimal infant health and development.

Traditionally, most infant formulas were derived from cow's milk; however, in recent years the use of soy-based infant formulas has become more common. Today, soy-based formulas comprise over 25% of the infant formula market. The popularity of soy-based formula is due in part to its amenability to infants with allergies or sensitivities to cow's milk protein, as well as infants with lactose intolerance. In addition, soy-based formulas are often prepared for infants with special nutritional difficulties such as gas, diarrhea, and frequent spit-up.

Despite these advantages, soy-based formulas present several nutritional difficulties. For example, soy-based, mineral-fortified infant formulas often produce hard stools and constipation in some infants. These digestive difficulties are caused, in part, by the high levels of mineral fortification and phytate found in many soy-based formulas.

Phytate, also known as phytic acid or inositol hexaphosphate, is a high phosphate ester of inositol. Soybean products typically contain high levels of phytate, ranging from about 1.2% to 4.0% phytate by weight. Phytate readily forms phytate-mineral-protein complexes that are indigestible. These complexes can interfere with the absorption of nutritionally essential multi-valent cations, such as calcium, iron, and zinc. These nutrients are important for the growth and development of an infant and thus must be present in the infant's diet.

In order to compensate for the mineral-binding effects of phytate, soy-based infant formulas are typically fortified with nutrients such as calcium and iron. While breast milk typically contains about 50.4 mg/100 kcal calcium, soy-based infant formulas are often fortified so that they contain about 100 mg/100 kcal calcium. Unfortunately, this calcium fortification often causes additional stool hardness and constipation in infants. Though not wishing to be bound to this or any other theory, it is believed that constipation is caused when excess calcium complexes with fatty acids to form calcium palmitate soaps. The formation of these soaps has been positively correlated with stool hardness. Quinlan, et al., The Relationship Between Stool Hardness and Stool Composition in Breast and Formula-Fed Infants. J Pediatr. Gastroenterol. Nutr. 20:81-90 (1995). The present invention, therefore, seeks to reduce the constipation caused by excess calcium. By reducing phytate levels in the infant formula, the present invention reduces the need for calcium fortification, thus reducing infant constipation.

### SUMMARY OF THE INVENTION

Briefly, the present invention is directed, in a particular embodiment, to a novel infant formula comprising, per 100 kcal, a carbohydrate source; a lipid source; a soy protein source, wherein the soy protein source has a phytate level between 12 mg and 18 mg; and calcium in an amount between about 70 mg and 90 mg.

In an embodiment, the present invention is also directed to an infant formula comprising, per 100 kcal, a carbohydrate source, a lipid source, a soy protein source, and a calcium source. The soy protein source has a phytate level of about 15 mg and the calcium is present in an amount of about 85 mg.

The invention is also directed, in an embodiment, to an infant formula comprising, per 100 kcal, a carbohydrate source, a lipid source, between about 1.8 and 2.5 g of a soy protein source, and about 85 mg of calcium. The soy protein source has a phytate level of about 15 mg.

In yet another embodiment, the invention is directed to an infant formula comprising, per 100 kcal, about 10.6 g of a carbohydrate source, about 5.3 g of a lipid source, about 2.3 g of a soy protein source, and about 85 mg of calcium. The soy protein source has a phytate level of about 15 mg.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment.

Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

The term “phytate” refers generally to inositol hexaphosphate, but in the context of the present invention can also include inositol pentaphosphate, inositol tetraphosphate, inositol triphosphate, inositol diphosphate, and inositol monophosphate. The term “phytate” also includes phytic acid.

The terms “partially hydrolyzed” mean a degree of hydrolysis which is greater than 0%, but less than about 50%.

The terms “extensively hydrolyzed” mean a degree of hydrolysis which is greater than or equal to about 50%.

As used herein, the term “prebiotic” means a non-digestible food ingredient that beneficially affects the host by selectively stimulating the growth and/or activity of one or a limited number of bacteria in the colon that can improve the health of the host.

The term “probiotic” can encompass any bacteria that exerts beneficial effects on the health of its host.

As used herein, the term “infant” means a human that is less than about one year old.

As used herein, the term “infant formula” means a composition that satisfies the nutrient requirements of an infant by being a substitute for human milk.

In an embodiment the infant formula has, per 100 kcal, a carbohydrate source, a lipid source, a soy protein source, and a calcium source. The soy protein source can have a phytate level between about 12 mg and about 18 mg. The calcium can be present in an amount between about 70 and about 90 mg.

In one embodiment of the present invention, the phytate level of the infant formula can be between about 10 and 20 mg/100 kcal. In another embodiment of the present invention, the phytate level of the infant formula can be between about 15 and 20 mg/100 kcal. In yet another embodiment the phytate level of the infant formula can be between about 15 and 18 mg/100 kcal. In other embodiments, the phytate level of the infant formula can be between about 15 and 16 mg/100 kcal. In yet another embodiment of the invention, the phytate level of the infant formula can be about 15 mg/100 kcal.

In one embodiment, the calcium content of the infant formula can be between about 70 and 95 mg/100 kcal. In another embodiment, the calcium content of the infant formula can be between about 70 and 90 mg/100 kcal. In yet another embodiment, the calcium content of the infant formula can be between about 80 and 90 mg/100 kcal. In other embodiments, the calcium content of the infant formula may be about 85 mg/100 kcal.

The phytate level in the infant formula may be reduced using any method known in the art. For example the phytate content may be reduced in the soy protein using ion exchange resins or by treating a soy protein source with one or more enzymes followed by ultrafiltration. Alternatively, the phytate content may be reduced in the soy protein by alkali treatment and ultrafiltration. These and other process for reducing the phytate content in soy proteins are known to those skilled in the art and are useful in any embodiment of the present invention. Similarly, methods of calcium fortification are well known in the prior art and any known method can be utilized in any embodiment of the present invention.

In one embodiment of the invention, the soy protein can be isolated soy protein. The soy protein isolate of the present invention may be prepared using any method known in the art. In another embodiment, the soy protein can be soy protein concentrate. The soy protein concentrate of the present invention can be prepared using any method known in the art.

In yet another embodiment of the invention, the soy protein can be hydrolyzed. In this embodiment, the soy protein may be partially or extensively hydrolyzed.

The infant formula of the present invention may be nutritionally complete and can contain suitable types and amounts of lipid, carbohydrate, protein, vitamins and minerals. The amount of lipid or fat can typically vary from about 3 to about 7 g/100 kcal. Lipid sources can be any known in the art, including vegetable oils such as palm oil, soybean oil, palmolein, coconut oil, medium chain triglyceride oil, high oleic sunflower oil, high oleic safflower oil, and the like. The lipid sources may be structured lipids or re-esterified vegetable oils. The amount of carbohydrate can typically vary from about 8 to about 12 g/100 kcal. Any carbohydrate source known in the art can be useful in an embodiment of the invention.

The amount of protein can typically vary from about 1 to about 5 g/100 kcal. In an embodiment, the amount of soy protein in the infant formula may be between about 1.8 and 2.5 g/100 kCal. In a particular embodiment, the amount of soy protein in the infant formula may be between about 2.0 and 2.5 g/100 kCal. In other embodiments, the amount of soy protein in the infant formula may be between about 2.2 and 2.4 g/100 kCal. In yet another embodiment the amount of soy protein in an infant formula of the present invention may be about 2.3g/100 kCal.

A method for reducing or preventing constipation in an infant is additionally provided. The method comprises administering to the infant an infant formula according to an embodiment of the present invention. A method for softening the stools of an infant is further provided. The method comprises administering to the infant an infant formula according to an embodiment of the present invention.

In one embodiment the infant formula may be in powder form. In another embodiment, the infant formula may be in liquid form. In yet another embodiment of the invention, the infant formula may be in ready-mixed form and may be ready-to-feed.

In a particular embodiment of the invention, the infant formula may contain one or more prebiotics. Any prebiotic known in the art will be acceptable in this embodiment. Prebiotics of the present invention may include, but are not limited to, lactulose, galacto-oligosaccharide, fructo-oligosaccharide, isomalto-oligosaccharide, lactosucrose, polydextrose, inulin, gluco-oligosaccharide, xylo-oligosacchairde, and gentio-oligosaccharides. In some embodiments of the invention, the prebiotic and phytate have a synergistic effect.

In another embodiment of the invention, the infant formula may contain one or more probiotics. In this embodiment, any probiotic known in the art will be acceptable. Probiotics may include, but are not limited to, members of the genera Lactobacillus or Bifidobacterium. The probiotic may include Lactobacillus rhamnosus GG or Bifidobacterium lactis Bb-12.

In other embodiments of the present invention, the infant formula may contain other components such as long chain polyunsaturated fatty acids (LCPUFA). Suitable LCPUFAs may include, but are not limited to, α-linoleic acid, γ-linoleic acid, linoleic acid, linolenic acid, eicosapentaenoic acid (EPA), arachidonic acid (ARA) and docosahexaenoic acid (DHA). In an embodiment, the infant formula contains DHA. In another embodiment, the infant formula contains ARA. In yet another embodiment, the infant formula contains both DHA and ARA.

In one embodiment, both DHA and ARA are incorporated into the infant formula of the present invention. In this embodiment, the weight ratio of ARA:DHA is typically from about 1:3 to about 9:1. Alternatively, this ratio can be from about 1:2 to about 4:1. In yet another alternative, the ratio can be from about 2:3 to about 2:1. In one particular embodiment, the ratio is about 2:1.

The effective amount of DHA in an embodiment of the present invention is typically from about 3 mg per kg of body weight per day to about 150 mg per kg of body weight per day. In one embodiment of the invention, the amount of DHA is from about 6 mg per kg of body weight per day to about 100 mg per kg of body weight per day. In another embodiment, the amount is from about 10 mg per kg of body weight per day to about 60 mg per kg of body weight per day. In yet another embodiment, the amount is from about 15 mg per kg of body weight per day to about 30 mg per kg of body weight per day.

The amount of DHA in infant formulas for use in an embodiment of the present invention typically varies from about 5 mg/100 kcal to about 80 mg/100 kcal. In one embodiment of the present invention the amount of DHA varies from about 10 mg/100 kcal to about 50 mg/100 kcal; and in another embodiment it varies from about 15 mg/100 kcal to about 20 mg/100 kcal. In a particular embodiment of the present invention, the amount of DHA is about 17 mg/100 kcal.

The effective amount of ARA in an embodiment of the present invention is typically from about 5 mg per kg of body weight per day to about 150 mg per kg of body weight per day. In one embodiment of this invention, the amount of ARA varies from about 10 mg per kg of body weight per day to about 120 mg per kg of body weight per day. In another embodiment, the amount varies from about 15 mg per kg of body weight per day to about 90 mg per kg of body weight per day. In yet another embodiment, the amount varies from about 20 mg per kg of body weight per day to about 60 mg per kg of body weight per day.

The amount of ARA in infant formulas for use in an embodiment of the present invention typically varies from about 10 mg/100 kcal to about 100 mg/100 kcal. In one embodiment of the present invention, the amount of ARA varies from about 15 mg/100 kcal to about 70 mg/100 kcal. In another embodiment the amount of ARA varies from about 20 mg/100 kcal to about 40 mg/100 kcal. In a particular embodiment of the present invention, the amount of ARA is about 34 mg/100 kcal.

DHA and ARA can be supplemented into any embodiment of the present invention using standard techniques known in the art. For example, DHA and ARA can be added to the supplement or formula by replacing an equivalent amount of an oil, such as high oleic sunflower oil, normally present in the formula. As another example, the oils containing DHA and ARA can be added to the supplement or formula by replacing an equivalent amount of the rest of the overall fat blend normally present in the formula without DHA and ARA.

The source of DHA and ARA can be any source known in the art. In an embodiment of the present invention, sources of DHA and ARA are single cell oils. However, the present invention is not limited to only such oils. DHA and ARA can be utilized in natural or refined form.

In one embodiment, the source of DHA and ARA is substantially free of eicosapentaenoic acid (EPA). For example, in one embodiment of the present invention the infant formula contains less than about 16 mg EPA/100 kcal; in another embodiment less than about 10 mg EPA/100 kcal; and in yet another embodiment less than about 5 mg EPA/100 kcal. One particular embodiment contains substantially no EPA. Another embodiment is free of EPA in that even trace amounts of EPA are absent from the formula.

In an embodiment, the invention comprises the use of a carbohydrate source, a lipid source, a soy protein source, and calcium in the preparation of an infant formula for softening stools in infants. In this embodiment, the soy protein source has a phytate level between about 12 mg and 18 mg and calcium is present in an amount between about 70 mg and 90 mg. In another embodiment, the invention comprises the use of a carbohydrate source, a lipid source, a soy protein source, and calcium in the preparation of an infant formula for reducing or preventing constipation in infants. In this embodiment, the soy protein source has a phytate level between about 12 mg and 18 mg and calcium is present in an amount between about 70 mg and 90 mg.

The following examples describe various embodiments of the present invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples, all percentages are given on a weight basis unless otherwise indicated.

### EXAMPLE 1

This example illustrates an embodiment of an infant formula of the present invention.

| | Per 100 Calories |
|---|---|
| Ingredient | (5 fl oz) |
| Protein, g | 2.3 |
| Phytate, mg | 15 |
| Fat, g | 5.3 |
| Carbohydrate, g | 10.6 |
| Water, g | 134 |
| Linoleic acid, mg | 860 |
| Vitamin A, IU | 300 |
| Vitamin D, IU | 60 |
| Vitamin E, IU | 2 |
| Vitamin K, μg | 8 |
| Thiamin (Vitamin B1), μg | 80 |
| Riboflavin (Vitamin B2), μg | 90 |
| Vitamin B6, μg | 60 |
| Vitamin B12, μg | 0.3 |
| Niacin, μg | 1000 |
| Folic acid (folacin), μg | 16 |
| Pantothenic acid, μg | 500 |
| Biotin, μg | 3 |
| Vitamin C (Ascorbic acid), mg | 12 |
| Choline, mg | 12 |
| Inositol, mg | 6 |
| Calcium, mg | 85 |
| Phosphorus, mg | 83 |
| Magnesium, mg | 11 |
| Iron, mg | 1.8 |
| Zinc, mg | 1.0 |
| Manganese, μg | 25 |
| Copper, μg | 75 |
| Iodine, μg | 15 |
| Selenium, μg | 2.8 |
| Sodium, mg | 36 |
| Potassium, mg | 120 |
| Chloride, mg | 80 |

### EXAMPLE 2

This example illustrates another embodiment of an infant formula of the present invention.

| | Per 100 Calories |
|---|---|
| Ingredient | (5 fl oz) |
| Protein, g | 2.3 |
| Phytate, mg | 15 |
| Fat, g | 5.3 |
| Linoleic acid, mg | 860 |
| DHA, mg | 17 |
| ARA, mg | 34 |
| Carbohydrate, g | 10.6 |
| Water, g | 133 |
| Vitamin A, IU | 300 |
| Vitamin D, IU | 60 |
| Vitamin E, IU | 2 |
| Vitamin K, μg | 8 |
| Thiamin (Vitamin B1), μg | 80 |
| Riboflavin (Vitamin B2), μg | 90 |
| Vitamin B6, μg | 60 |
| Vitamin B12, μg | 0.3 |
| Niacin, μg | 1000 |
| Folic acid (folacin), μg | 16 |
| Pantothenic acid, μg | 500 |
| Biotin, μg | 3 |
| Vitamin C (ascorbic acid), mg | 12 |
| Choline, mg | 12 |
| Inositol, mg | 6 |
| Carnitine, mg | 2 |
| Taurine, mg | 6 |
| Calcium, mg | 85 |
| Phosphorus, mg | 83 |
| Magnesium, mg | 11 |
| Iron, mg | 1.8 |
| Zinc, mg | 1.0 |
| Manganese, μg | 25 |
| Copper, μg | 75 |
| Iodine, μg | 15 |
| Selenium, μg | 2.8 |
| Sodium, mg | 36 |
| Potassium, mg | 120 |
| Chloride, mg | 80 |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties to the extent that they do not conflict with anything stated herein. The discussion of the references herein is intended merely to summarize the assertions made by their authors and no admission is made that any reference constitutes prior art. Applicants reserve the right to challenge the accuracy and pertinence of the cited references.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

What is claimed is:

1. An infant formula comprising, per 100 kcal:
a carbohydrate source;
a lipid source;
a soy protein source, wherein the soy protein source has a phytate level between about 12 mg and 18 mg; and
calcium in an amount between about 70 mg and 90 mg.

2. The infant formula according to claim 1, wherein the phytate level is between about 15 mg and 18 mg/100 kcal.

3. The infant formula according to claim 1, wherein the phytate level is between about 15 mg and 16 mg/100 kcal.

4. The infant formula according to claim 1, wherein the phytate level is about 15 mg/100 kcal.

5. The infant formula according to claim 1, wherein the amount of calcium is between about 80 mg and 90 mg/100 kcal.

6. The infant formula according to claim 1, wherein the amount of calcium is about 85 mg/100 kcal.

7. The infant formula according to claim 1, wherein the protein source comprises isolated soy protein.

8. The infant formula according to claim 1, wherein the protein source comprises soy protein concentrate.

9. The infant formula according to claim 1, wherein the soy protein source comprises hydrolyzed protein.

10. The infant formula according to claim 9, wherein the soy protein source comprises partially hydrolyzed protein.

11. The infant formula according to claim 9, wherein the soy protein source comprises extensively hydrolyzed protein.

12. The infant formula according to claim 1, wherein the form infant formula is selected from the group consisting of powder, liquid and ready-to-feed.

13. The infant formula according to claim 1, wherein the infant formula additionally comprises at least one prebiotic.

14. The infant formula according to claim 13, wherein the prebiotic is selected from the group consisting of lactulose, galacto-oligosaccharide, fructo-oligosaccharide, isomalto-oligosaccharide, lactosucrose, polydextrose, inulin, gluco-oligosaccharide, xylo-oligosacchairde, and gentio-oligosaccharides.

15. The infant formula according to claim 13, wherein the prebiotic and the phytate have a synergistic effect.

16. The infant formula according to claim 1, wherein the infant formula additionally comprises at least one probiotic.

17. The infant formula according to claim 16, wherein the probiotic is selected from the group consisting of Lactobacillus and Bifidobacterium.

18. The infant formula according to claim 1, wherein the infant formula additionally comprises at least one LCPUFA.

19. The infant formula according to claim 18, wherein the LCPUFA is selected from the group consisting of α-linoleic acid, γ-linoleic acid, linoleic acid, linolenic acid, eicosapentaenoic acid, arachidonic acid and docosahexaenoic acid.

20. An infant formula comprising, per 100 kcal:
a carbohydrate source;
a lipid source;
a soy protein source, wherein the soy protein source has a phytate level of about 15 mg; and
calcium in an amount of about 85 mg.

21. An infant formula comprising, per 100 kcal:
a carbohydrate source;
a lipid source;
between about 1.8 and 2.5 g of a soy protein source, wherein the soy protein source has a phytate level of about 15 mg; and
calcium in an amount of about 85 mg.

22. An infant formula comprising, per 100 kcal:
about 10.6 g of a carbohydrate source;
about 5.3 g of a lipid source;
about 2.3 g of a soy protein source, wherein the soy protein source has a phytate level of about 15 mg; and
about 85 mg of calcium.

23. A method for reducing or preventing constipation in an infant, the method comprising administering to the infant an infant formula according to claim 1.

24. A method for softening the stools of an infant, the method comprising administering to the infant an infant formula according to claim 1.
